(19) United States
(12) Patent Application Publication
(10) Pub. No.: US 2009/0110114 A1
(43) Pub. Date: Apr. 30, 2009

(54) Open-Loop MIMO Scheme and Signaling Support for Wireless Networks

(76) Inventors: Eko Nugroho Onggosanusi, Allen, TX (US); Zukang Shen, Richardson, TX (US); Runhua Chen, Dallas, TX (US); Pierre Bertrand, Le Hameau des Roses (FR)

Correspondence Address: TEXAS INSTRUMENTS INCORPORATED, P O BOX 655474, M/S 3999, DALLAS, TX, 75265, US

(21) Appl. No.: 12/255,472

(22) Filed: Oct. 21, 2008

Related U.S. Application Data
(60) Provisional application No. 60/982,960, filed on Oct. 26, 2007.

(51) Int. Cl. H04L 27/00

(52) U.S. Cl. 375/299; 375/316

(57) ABSTRACT

Transmission with multiple antennas in a wireless network is performed by selecting between adaptive precoding and fixed precoding based on a selection criterion. Transmission using spatial multiplexing with adaptive precoding is performed if the selection criterion is fulfilled. Transmission using spatial multiplexing with fixed preceding is performed if the selection criterion is unfulfilled.

### CLAIM TO PRIORITY AND CROSS-REFERENCE TO RELATED APPLICATIONS

The present application claims priority to and incorporates by reference U.S. provisional application No. 60/982,960 (attorney docket TI-65543PS) filed on Oct. 26, 2007, entitled “Open-Loop MIMO Scheme and Signaling Support for E-UTRA.”

### FIELD OF THE INVENTION

This invention generally relates to wireless cellular communication, and in particular to multiple input multiple output (MIMO) transmission in orthogonal and single carrier frequency division multiple access (OFDMA) (SC-FDMA) systems.

### BACKGROUND OF THE INVENTION

Wireless cellular communication networks incorporate a number of mobile UEs and a number of NodeBs. A NodeB is generally a fixed station, and may also be called a base transceiver system (BTS), an access point (AP), a base station (BS), or some other equivalent terminology. As improvements of networks are made, the NodeB functionality evolves, so a NodeB is sometimes also referred to as an evolved NodeB (eNB). In general, NodeB hardware, when deployed, is fixed and stationary, while the UE hardware is portable.

In contrast to NodeB, the mobile UE can comprise portable hardware. User equipment (UE), also commonly referred to as a terminal or a mobile station, may be fixed or mobile device and may be a wireless device, a cellular phone, a personal digital assistant (PDA), a wireless modem card, and so on. Uplink communication (UL) refers to a communication from the mobile UE to the NodeB, whereas downlink (DL) refers to communication from the NodeB to the mobile UE. Each NodeB contains radio frequency transmitter(s) and the receiver(s) used to communicate directly with the mobiles, which move freely around it. Similarly, each mobile UE contains radio frequency transmitter(s) and the receiver(s) used to communicate directly with the NodeB. In cellular networks, the mobiles cannot communicate directly with each other but have to communicate with the NodeB.

Long Term Evolution (LTE) wireless networks, also known as Evolved Universal Terrestrial Radio Access (E-UTRA), are being standardized by the 3GPP working groups (WG). OFDMA and SC-FDMA (single carrier FDMA) access schemes were chosen for the down-link (DL) and up-link (UL) of E-UTRA, respectively. User Equipments (UE's) are time and frequency multiplexed on a physical uplink shared channel (PUSCH), and a fine time and frequency synchronization between UE's guarantees optimal intra-cell orthogonality. In case the UE is not UL synchronized, it uses a non-synchronized Physical Random Access Channel (PRACH), and the Base Station provides back some allocated UL resource and timing advance information to allow the UE to transmit on the PUSCH.

A reference signal (RS) is a pre-defined signal, pre-known to both transmitter and receiver. The RS can generally be thought of as deterministic from the perspective of both transmitter and receiver. The RS is typically transmitted in order for the receiver to estimate the signal propagation medium. This process is also known as “channel estimation.” Thus, an RS can be transmitted to facilitate channel estimation. Upon deriving channel estimates, these estimates are used for demodulation of transmitted information. This type of RS is sometimes referred to as De-Modulation RS or DM RS. Note that RS can also be transmitted for other purposes, such as channel sounding (SRS), synchronization, or any other purpose. Also note that Reference Signal (RS) can be sometimes called the pilot signal, or the training signal, or any other equivalent term.

The LTE PHY can optionally exploit multiple transceivers at both the base station and UE in order to enhance link robustness and increase data rates for the LTE downlink. Spatial diversity can be used to provide diversity against fading. In particular, maximal ratio combining (MRC) is used to enhance link reliability in challenging propagating conditions when signal strength is low and multipath conditions are challenging. Transmit diversity can be used to improve signal quality by transmitting the same data from multiple antennas to the receiver. Spatial multiplexing can be used to increase system capacity by carrying multiple data streams simultaneously from multiple antennas on the same frequency. Spatial multiplexing may be performed with one of the following cyclic delay diversity (CDD) preceding methods: zero-delay, small-delay, or large-delay CDD. Spatial multiplexing may also be referred to as MIMO (multiple input multiple output).

With MRC, a signal is received via two (or more) separate antenna/transceiver pairs. The antennas are physically separated, and therefore have distinct channel impulse responses. Channel compensation is applied to each received signal within the baseband processor before being linearly combined to create a single composite received signal. When combined in this manner, the received signals add coherently within the baseband processor. However, the thermal noise from each transceiver is uncorrelated, resulting in improved signal to noise ratio (SNR). MRC enhances link reliability, but it does not increase the nominal system data rate since data is transmitted by a single antenna and is processed at the receiver via two or more receivers. MRC is therefore a form of receiver diversity rather than more conventional antenna diversity.

MIMO, on the other hand, does increase system data rates. This is achieved by using multiple antennas on both the transmitting and receiving ends. In order to successfully receive a MIMO transmission, the receiver must determine the channel impulse response from each transmitting antenna. In LTE, channel impulse responses are determined by sequentially transmitting known reference signals from each transmitting antenna. While one transmitter antenna is sending the reference signal, the other antenna is idle. Once the channel impulse responses are known, data can be transmitted from both antennas simultaneously. The linear combination of the two data streams at the two receiver antennas results in a set of two equations and two unknowns, which is resolvable into the two original data streams.

Three different types of physical channels are defined for the LTE downlink. One common characteristic of physical channels is that they all convey information from higher layers in the LTE stack. This is in contrast to physical signals, which convey information that is used exclusively within the PHY layer. Currently, the LTE DL physical channels are as follows:
Physical Downlink Shared Channel, PDSCH
Physical Broadcast Channel, PBCH
Physical Multicast Channel, PMCH
Physical Control Format Indicator Channel, PCFICH
Physical Downlink Control Channel, PDCCH
Physical Hybrid ARQ Indicator Channel, PHICH

Physical channels are mapped to specific transport channels. Transport channels are SAPs for higher layers. Each physical channel has defined algorithms for:
Bit scrambling
Modulation
Layer mapping
CDD precoding
Resource element assignment

Layer mapping and precoding are related to MIMO applications. Basically, a layer corresponds to a spatial multiplexing channel. Channel rank can vary from one up to the minimum of number of transmit and receive antennas. For example, given a 4×2 system as an example, i.e., a system with four transmit antennas and two receive antennas, the maximum channel rank is two. The channel rank associated with a particular connection varies in time and frequency as the fast fading alters the channel coefficients. Moreover, the channel rank determines how many layers, also referred to as the transmission rank, can be successfully transmitted simultaneously. For example, if the channel rank is one at the instant of the transmission of two layers, there is a strong likelihood that the two signals corresponding to the two layers will interfere so much that both of the layers are erroneously detected at the receiver. In conjunction with preceding, adapting the transmission to the channel rank involves striving to use as many layers as the channel rank.

MIMO systems are defined in terms of M-transmitters×N-receivers. For LTE, defined configurations are M=1, 2, and 4 while the value of N is not specified. When M>N, there is redundancy on at least one of the data streams. Layer mapping specifies exactly how the extra transmitter antennas are employed.

Precoding is also used in conjunction with spatial multiplexing. MIMO exploits multipath to resolve independent spatial data streams. In other words, MIMO systems require a certain degree of multipath for reliable operation. In a noise-limited environment with low multipath distortion, MIMO systems can actually become impaired. The basic principle involved in precoding is to mix and distribute the modulation symbols over the antennas while potentially also taking the current channel conditions into account. Precoding can be implemented by, for example, multiplying the information carrying symbol vector containing modulation symbols by a matrix which is selected to match the channel based on a certain selection criterion. Some examples of selection criterion include average throughput and maximum signal-to-interference-noise ratio (SINR). Sequences of symbol vectors thus form a set of parallel symbol streams and each such symbol stream is referred to as a “layer”. Thus, depending on the choice of precoder in a particular implementation, a layer may directly correspond to a certain physical antenna or a layer may, via the precoder mapping, be distributed onto several physical antennas.

Cyclic delay diversity (CDD) is a form of open-loop precoding in which the precoding matrix is intentionally varied over the frequency within the transmission (or system) bandwidth. Typically, this is realized by introducing different cyclic time delay for the different antennas, or alternatively realized by varying the phase of the transmitted signals from the different antennas. This kind of phase shift means that the effective channel, comprising the true channel and the CDD preceding, varies faster over frequency than the original channel. By distributing the transmission over frequency, this kind of artificially induced frequency-selectivity may be useful in achieving frequency diversity.

Control information feedback bits are transmitted, for example, in the uplink (UL), for several purposes. For instance, Downlink Hybrid Automatic Repeat ReQuest (HARQ) requires at least one bit of ACK/NACK transmitted in the uplink, indicating successful or failed circular redundancy check(s) (CRC). Moreover, a one bit scheduling request indicator (SRI) is transmitted in uplink, when UE has new data arrival for transmission in uplink. Furthermore, an indicator of downlink channel quality (CQI) needs to be transmitted in the uplink to support mobile UE scheduling in the downlink. While CQI may be transmitted based on a periodic or triggered mechanism, the ACK/NACK needs to be transmitted in a timely manner to support the HARQ operation. Note that ACK/NACK is sometimes denoted as ACKNAK or just simply ACK, or any other equivalent term. This uplink control information is typically transmitted using the physical uplink control channel (PUCCH), as defined by the 3GPP working groups (WG), for evolved universal terrestrial radio access (EUTRA). The EUTRA is sometimes also referred to as 3GPP long-term evolution (3GPP LTE). The structure of the PUCCH is designed to provide sufficiently high transmission reliability.

Channel quality indicator (CQI) needs to be fed back in uplink (UL) to support dynamic scheduling and multiple-input-multiple-output (MIMO) transmission on downlink (DL). In 3GPP EUTRA, if a UE (user equipment) has no uplink data transmission, its CQI is transmitted on a dedicated UL control channel (i.e. PUCCH). For example, MIMO related feedback information includes: index of a selected precoding matrix (PMI); transmission rank, which is the number of spatial transmission layers; and supportable modulation and coding schemes (MCS). Otherwise, the corresponding CQI is transmitted together with the UL data by multiplexing the CQI with the UL data in the physical uplink shared channel (PUSCH).

### BRIEF DESCRIPTION OF THE DRAWINGS

Particular embodiments in accordance with the invention will now be described, by way of example only, and with reference to the accompanying drawings:

FIG. 1 is a pictorial of an illustrative telecommunications network that supports transmission of multiplexed RA preambles having a selected CP duration;

FIG. 2 is a block diagram of an illustrative transmitter for transmission of a MIMO signal in the network of FIG. 1 according to an embodiment of the invention;

FIG. 3 is a flow diagram illustrating operation of open-loop MIMO transmission; and

FIG. 4 is a block diagram illustrating the network system of FIG. 1.

### DETAILED DESCRIPTION OF EMBODIMENTS OF THE INVENTION

The 3GPP E-UTRA system supports a competitive multi-input multi-output (MIMO) scheme which allows dynamic rank (the number of spatial layers) adaptation along with adaptive precoding for both 2- and 4-antenna systems. There are two precoding modes for the E-UTRA, as defined in 3GPP TS 36.211 V8.0.0, “Physical Channels and Modulation”:
Precoded without CDD (“zero-delay” CDD)
Precoded large-delay CDD

Adaptive precoding is generally intended for low UE speed. For DL, adaptive precoding is enabled by a feedback called PMI (precoding matrix indicator) from the receiver (UE) to the transmitter (eNB). Due to the processing at the eNB and UE, there is some delay between the PMI and the time (subframe) where the eNB transmits using the recommended precoder. Hence, the delay makes the feedback more outdated (stale) as the UE speed increases. Also, PMI feedback is not sent every subframe which further contributes to the delay. In the E-UTRA system, PMI is transmitted together with CQI.

The same principle holds for UL multi-antenna transmission as well. Although there is no PMI feedback, the eNB estimates the channel from received signals such as the sounding reference signal (SRS), which is also periodically sent but not every subframe, thereby rendering the channel estimates stale.

In order to provide a suitable spatial multiplexing scheme for high UE speed to obtain the throughput gain of MIMO, an open-loop spatial multiplexing (OL SM) scheme is more suitable. Here, open-loop refers to the absence of adaptive precoding, not the absence of link adaptation. Furthermore, dynamic rank adaptation can still be supported between open-loop T× diversity (OL T×D) and open-loop spatial multiplexing. the number of transmission layers is adapted based on a channel-dependent rank indicator feedback transmission.

The support of OL SM may require some additional signaling support (signaling tailored to OL SM) as well as the potential introduction of a new transmission mode on top the OL T×D. Note that there are numerous OL SM candidates, e.g. SM with linear dispersion code, higher rank extension of SFBC, large delay CDD with precoder cycling, etc. However, since the E-UTRA already includes a number of UE-mandatory schemes, introducing a new mode is undesirable from receiver development and testing perspective.

A solution which allows the support of OL SM without introducing a new scheme and signaling support will now be described herein that fully reuses the existing spatial multiplexing scheme that is defined for adaptive preceding. The disclosed embodiments of the invention are applicable to various wireless networks, including Evolved Universal Terrestrial Radio Access Network (E-UTRAN). The disclosed embodiments include apparatus for transmitting and receiving OL SM signals and methods for transmitting and receiving OL SM signals.

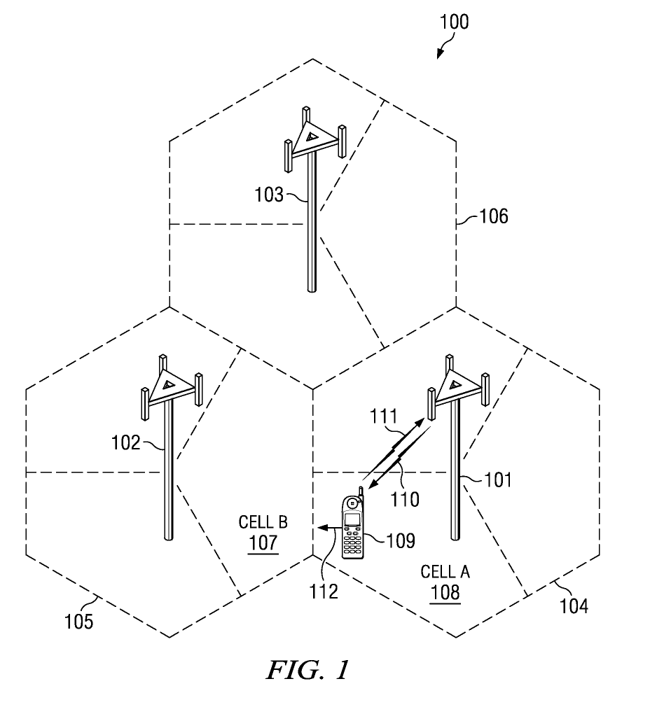

FIG. 1 shows an illustrative wireless telecommunications network 100 that supports transmission and reception of OL SM signals, as described in more detail below. The illustrative telecommunications network includes base stations 101, 102, and 103, though in operation, a telecommunications network may include more base stations or fewer base stations. Each of base stations 101, 102, and 103 is operable over corresponding coverage areas 104, 105, and 106. Each base station's coverage area is further divided into cells. In the illustrated network, each base station's coverage area is divided into three cells. Handset or other UE 109 is shown in Cell A 108, which is within coverage area 104 of base station 101. Base station 101 is transmitting to and receiving transmissions from UE 109. As UE 109 moves out of Cell A 108, and into Cell B 107, UE 109 may be “handed over” to base station 102. Assuming that UE 109 is synchronized with base station 101, UE 109 likely employs non-synchronized random access to initiate handover to base station 102. The distance over which a random access signal is recognizable by base station 101 is a factor in determining cell size.

When UE 109 is not up-link synchronized with base station 101, non-synchronized UE 109 employs non-synchronous random access (NSRA) to request allocation of up-link 111 time or frequency or code resources. If UE 109 has data ready for transmission, for example, traffic data, measurements report, tracking area update, etc., UE 109 can transmit a random access signal on up-link 111 to base station 101. The random access signal notifies base station 101 that UE 109 requires up-link resources to transmit the UE's data. Base station 101 responds by transmitting to UE 109, via down-link 110, a message containing the parameters of the resources allocated for UE 109 up-link transmission along with a possible timing error correction. After receiving the resource allocation and a possible timing adjustment message transmitted on down-link 110 by base station 101, UE 109 may adjust its transmit timing, to bring the UE 109 into synchronization with base station 101, and transmit the data on up-link 111 employing the allotted resources during the prescribed time interval.

Once the UE is synchronized, the eNB may send data on DL in MIMO mode. UE 109 is traveling in a direction with a ground speed as indicated by 112. The direction and ground speed results in a speed component that is relative to serving eNodeB 101. Due to this relative speed of UE moving toward or away from its serving eNodeB a Doppler shift occurs in the signals being transmitted from the UE to the eNodeB resulting in a frequency shift and/or frequency spread that is speed dependent. In order to minimize problems with closed loop precoding selection due to stale channel estimates, the eNB may elect to operate in either an adaptive precoding manner or in a fixed precoding manner based on a selection criterion. Such selection criterion may involve UE velocity which may be inferred based on Doppler measurements, as well as some other factors such as the inter-cell interference condition (e.g. its burstiness). As an example, fixed precoding is selected for use above a certain velocity while adaptive preceding is selected for use below the certain velocity.

In particular, to support the operation at higher UE speed, either zero-delay or large-delay CDD mode can be used. In either case, the precoding matrix is fixed and not adapted. That is, the preceding matrix is fixed to be one of the matrices within the precoding codebook without any precoding adaptation. This does not introduce a new scheme as it is simply the existing precoded spatial multiplexing with one precoding matrix selected all the time. This can be accomplished without requiring any additional signaling support. The existing precoder subset restriction can be used (via higher layer signaling). Since a flexible bitmap approach is used to restrict the subset, the eNB can semi-statically restrict the precoder subset to one element for transmission ranks 2, 3, and 4. For rank-1, OL T×D is used so preceding is not used. The UE responds to the subset restriction by always selecting the corresponding precoding matrix for each rank. If necessary, a CQI feedback format that excludes PMI can be used. Alternatively, the original CQI feedback format (with PMI) may also be used if an additional CQI format is not desired.

While one matrix is sufficient for the purpose, it is also possible to perform fixed precoding by using a fixed subset of the precoding codebook that contains M precoding matrices where M>1. Since channel-dependent (adaptive) preceding is not performed, the precoding matrix is chosen alternately from the M matrices based on a pre-determined or a pseudo-random pattern. That is, the precoding matrix hops from one to another of the M matrices. Such precoding matrix hopping operation can be done across frequency sub-carriers, OFDM symbols, and/or subframes.

When the UE speed changes, the eNB can return to the normal (adaptive) precoded transmission. This can be done by changing the precoder subset restriction. Hence, the operation can be made transparent to the PHY layer, unless a separate no-PMI CQI feedback format is used for OL SM. Even if PMI is fed back to the eNB, the eNB does not need to read the PMI feedback from the UE. Alternative, a transmission mode configuration signal can also be used for the switching purpose.

As an example, consider the closed loop setup given in the 3GPP E-UTRA specification TS36.211 V8.0.0. For spatial multiplexed transmission with adaptive precoding on two antenna ports, p ε {0,1}, the precoding matrix W(i) corresponding to the -th sub-carrier for zero and large-delay CDD may be selected from Table 1. In this case, an open-loop spatial multiplexing scheme can be obtained by selecting W(i)=C₁ for the two-layer transmission. Here, C₁ denotes the precoding matrix corresponding to precoder index 0 in Table 1. For spatial multiplexed transmission with adaptive precoding on four antenna ports, p ε {0,1,2,3}, the precoding matrix W(i) for zero and large-delay CDD may be selected from Table 2. In this case, an open-loop spatial multiplexing scheme can be obtained by selecting W(i)=Cₖ for the two-, three-, and four-layer transmissions, where k is the precoder index given by a pre-determined mapping function. An example is:

$$k = ( ⌊ \frac{i}{υ} ⌋ mod 4 ) + 1 ,$$

where k=1,2,3,4, v is the number of transmission layers, and Cₖ, C₂, C₃, C₄ denote precoder matrices corresponding to precoder indices 12, 13, 14 and 15, respectively, in Table 2. In either case, OL T×D is used for single-layer transmission.

TABLE 1
Codebook for transmission on antenna ports {0,1}.

| Codebook | Number of layers υ | |
|---|---|---|
| index | 1 | 2 |
| 0 | $[ \begin{matrix}1 \\ 0\end{matrix} ]$ | $\frac{1}{\sqrt{2}} [ \begin{matrix}1 & 0 \\ 0 & 1\end{matrix} ]$ |
| 1 | $[ \begin{matrix}0 \\ 1\end{matrix} ]$ | $\frac{1}{2} [ \begin{matrix}1 & 1 \\ 1 & - 1\end{matrix} ]$ |
| 2 | $\frac{1}{\sqrt{2}} [ \begin{matrix}1 \\ 1\end{matrix} ]$ | $\frac{1}{2} [ \begin{matrix}1 & 1 \\ j & - j\end{matrix} ]$ |
| 3 | $\frac{1}{\sqrt{2}} [ \begin{matrix} 1 \\ - 1\end{matrix} ]$ | — |
| 4 | $\frac{1}{\sqrt{2}} [ \begin{matrix}1 \\ j\end{matrix} ]$ | — |
| 5 | $\frac{1}{\sqrt{2}} [ \begin{matrix} 1 \\ - j\end{matrix} ]$ | — |

TABLE 2
Codebook for transmission on antenna ports {0, 1, 2, 3}. Wₙ = I − 2uₙuₙ^{H}/uₙ^{H}uₙ

| Codebook | | Number of layers ν | | | |
|---|---|---|---|---|---|
| index | uₙ | 1 | 2 | 3 | 4 |
| 0 | u₀ = [1 −1 −1 −1]^{T} | W₀^{{1}} | W₀^{{14}}/\sqrt{2} | W₀^{{124}}/\sqrt{3} | W₀^{{1234}}/2 |
| 1 | u₁ = [1 −j 1 j]^{T} | W₁^{{1}} | W₁^{{12}}/\sqrt{2} | W₁^{{123}}/\sqrt{3} | W₁^{{1234}}/2 |
| 2 | u₂ = [1 1 −1 1]^{T} | W₂^{{1}} | W₂^{{12}}/\sqrt{2} | W₂^{{123}}/\sqrt{3} | W₂^{{3214}}/2 |
| 3 | u₃ = [1 j 1 −j]^{T} | W₃^{{1}} | W₃^{{12}}/\sqrt{2} | W₃^{{123}}/\sqrt{3} | W₃^{{3214}}/2 |
| 4 | u₄ = [1 (−1 − j)/\sqrt{2} − j (1 − j)/\sqrt{2}]^{T} | W₄^{{1}} | W₄^{{14}}/\sqrt{2} | W₄^{{124}}/\sqrt{3} | W₄^{{1234}}/2 |
| 5 | u₅ = [1 (1 − j)/\sqrt{2} j (−1 − j)/\sqrt{2}]^{T} | W₅^{{1}} | W₅^{{14}}/\sqrt{2} | W₅^{{124}}/\sqrt{3} | W₅^{{1234}}/2 |
| 6 | u₆ = [1 (1 + j)/\sqrt{2} − j (−1 + j)/\sqrt{2}]^{T} | W₆^{{1}} | W₆^{{13}}/\sqrt{2} | W₆^{{134}}/\sqrt{3} | W₆^{{1324}}/2 |
| 7 | u₇ = [1 (−1 + j)/\sqrt{2} j (1 + j)/\sqrt{2}]^{T} | W₇^{{1}} | W₇^{{13}}/\sqrt{2} | W₇^{{134}}/\sqrt{3} | W₇^{{1324}}/2 |
| 8 | u₈ = [1 −1 1 1]^{T} | W₈^{{1}} | W₈^{{12}}/\sqrt{2} | W₈^{{124}}/\sqrt{3} | W₈^{{1234}}/2 |
| 9 | u₉ = [1 −j −1 −j]^{T} | W₉^{{1}} | W₉^{{14}}/\sqrt{2} | W₉^{{134}}/\sqrt{3} | W₉^{{1234}}/2 |
| 10 | u₁₀ = [1 1 1 −1]^{T} | W₁₀^{{1}} | W₁₀^{{13}}/\sqrt{2} | W₁₀^{{123}}/\sqrt{3} | W₁₀^{{1324}}/2 |
| 11 | u₁₁ = [1 j −1 j]^{T} | W₁₁^{{1}} | W₁₁^{{13}}/\sqrt{2} | W₁₁^{{134}}/\sqrt{3} | W₁₁^{{1324}}/2 |
| 12 | u₁₂ = [1 −1 −1 1]^{T} | W₁₂^{{1}} | W₁₂^{{12}}/\sqrt{2} | W₁₂^{{123}}/\sqrt{3} | W₁₂^{{1234}}/2 |
| 13 | u₁₃ = [1 −1 1 −1]^{T} | W₁₃^{{1}} | W₁₃^{{13}}/\sqrt{2} | W₁₃^{{123}}/\sqrt{3} | W₁₃^{{1324}}/2 |
| 14 | u₁₄ = [1 1 −1 −1]^{T} | W₁₄^{{1}} | W₁₄^{{13}}/\sqrt{2} | W₁₄^{{123}}/\sqrt{3} | W₁₄^{{3214}}/2 |
| 15 | u₁₅ = [1 1 1 1]^{T} | W₁₅^{{1}} | W₁₅^{{12}}/\sqrt{2} | W₁₅^{{123}}/\sqrt{3} | W₁₅^{{1234}}/2 |

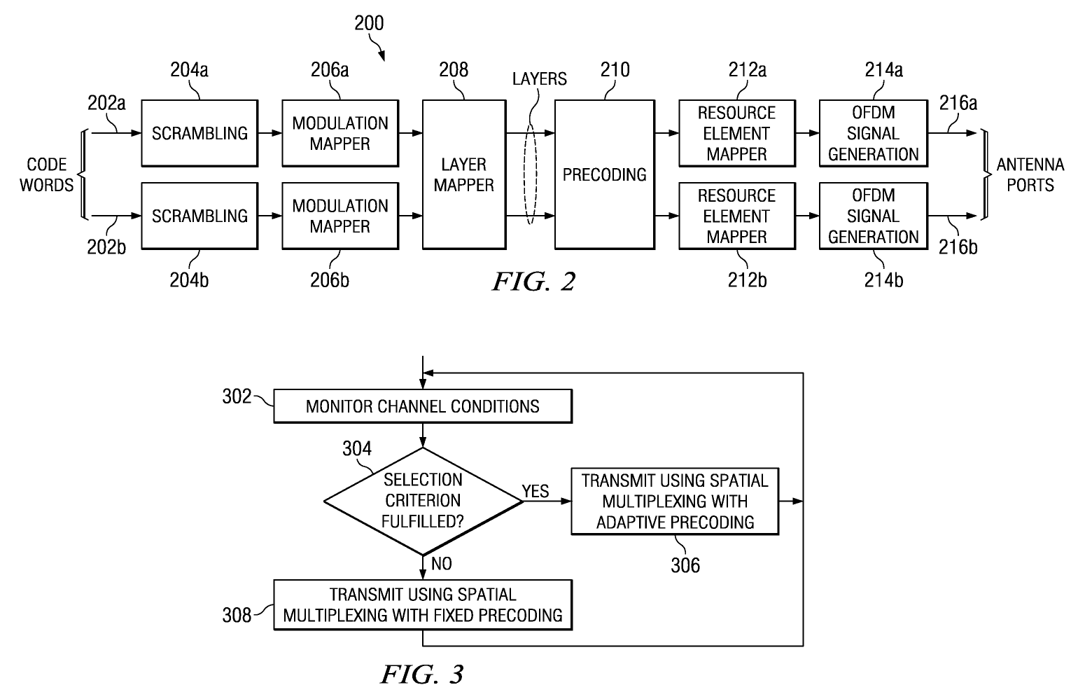

FIG. 2 is a block diagram of an illustrative transmitter 200 for transmission of a MIMO signal. A baseband signal representing a downlink physical channel is formed by providing a stream of code words 202a,b to scrambling logic 204a,b. In this embodiment, there are two transmission layers illustrated which are indicated by 202a and 202b, etc. Other embodiments may have additional layers.

Scrambling logic 204a,b scrambles the coded bits in each of the code words to be transmitted on a physical channel. The scrambled bits are then provided to modulation mapper logic 206a,b which maps the scrambled bits to modulation constellations to generate complex-valued modulation symbols. For example, the PDSCH may use on of the following modulation schemes: QPSK (quaternary phase shift keying), 16QAM (quaternary amplitude modulation) or 64QAM.

The modulated symbols are then provided to layer mapping logic 208 for mapping of the complex-valued modulation symbols onto one of several transmission layers. The number of layers v is less than or equal to the number of antenna ports P used for transmission of the physical channel.

The resulting complex-valued modulation symbols on each layer are then precoded for transmission on the antenna ports as described in more detail above with reference to Tables 1-2.

The complex-valued modulation symbols for each antenna port are then mapped to resource elements in resource element mappers 212a,b. For each of the antenna ports used for transmission of the physical channel, the block of complex-valued symbols y^{(p)}(0), . . . , y^{(p)}(M_{symb}^{ap}−1) are be mapped in sequence starting with y^{(P)}(0) to virtual resource blocks assigned for transmission. The mapping to resource elements (k,l) on antenna port p not reserved for other purposes are in increasing order of first the index k and then the index l, starting with the first slot in a subframe.

The resource mapped symbols are then provided to OFDM signal generation logic 214a,b for the generation of complex-valued time-domain OFDM signals 216a,b for each antenna port.

FIG. 3 is a flow diagram illustrating operation of open-loop MIMO transmission. During transmission to a particular UE, an eNB monitors 302 channel conditions to adapt to the prevailing condition. This includes monitoring the channel quality indicator (CQI) feedback provided on the uplink channel. It also includes determining when the channel conditions are not conducive to adaptive precoding for spatial multiplexing transmission. One selection criterion is velocity of the UE. The eNB may estimate velocity using Doppler shift, for example.

When the selection criterion is fulfilled 304, the eNB transmits 306 to the UE using a spatial multiplexed signal with adaptive preceding. Adaptive precoding is performed by dynamically selecting a precoding matrix from codebook Table 1 or 2, depending on the number of transmitting antenna. Each time a selection is made, the index value is signaled to the UE so that it knows how to demodulate the received signal. Typically, for lower velocity operation, adaptive precoding is selected. The transmission signal is formed as generally illustrated with reference to FIG. 2.

When the selection criterion is not fulfilled 304, the eNB transmits 308 to the UE using a spatial multiplexed signal with fixed preceding. Fixed precoding is performed by selecting one precoding matrix from codebook Table 1 or 2, depending on the number of transmitting antenna. When a selection is made, the index value is signaled to the UE so that it knows how to demodulate the received signal. Typically, for higher velocity operation, fixed precoding is selected. The transmission signal is formed as generally illustrated with reference to FIG. 2.

### System Examples

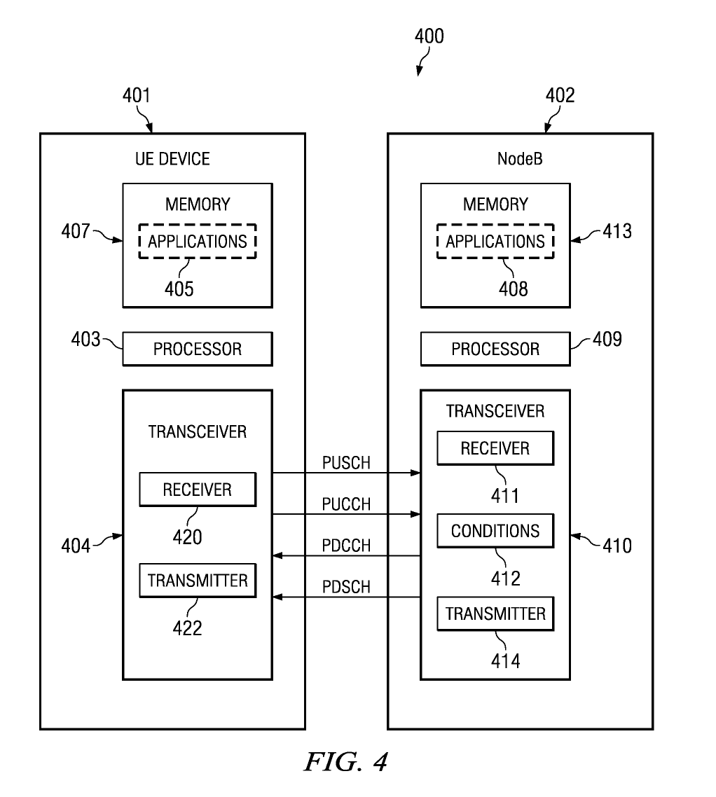

FIG. 4 is a block diagram illustrating the network system of FIG. 1. As shown in FIG. 4, the wireless networking system 400 comprises a mobile UE device 401 in communication with an eNB 402. The mobile UE device 401 may represent any of a variety of devices such as a server, a desktop computer, a laptop computer, a cellular phone, a Personal Digital Assistant (PDA), a smart phone or other electronic devices. In some embodiments, the electronic mobile UE device 401 communicates with the eNB 402 based on a LTE or E-UTRA protocol. Alternatively, another communication protocol now known or later developed can be used.

As shown, the mobile UE device 401 comprises a processor 403 coupled to a memory 407 and a Transceiver 404. The memory 407 stores (software) applications 405 for execution by the processor 403. The applications 405 could comprise any known or future application useful for individuals or organizations. As an example, such applications 405 could be categorized as operating systems (OS), device drivers, databases, multimedia tools, presentation tools, Internet browsers, e-mailers, Voice-Over-Internet Protocol (VOIP) tools, file browsers, firewalls, instant messaging, finance tools, games, word processors or other categories. Regardless of the exact nature of the applications 405, at least some of the applications 405 may direct eNB (base-station) 402 to transmit DL signals to mobile UE device 401 periodically or continuously via the transceiver 404.

Transceiver 404 includes uplink logic which may be implemented by execution of instructions that control the operation of the transceiver. Some of these instructions may be stored in memory 407 and executed when needed. As would be understood by one of skill in the art, the components of the Uplink Logic may involve the physical (PHY) layer and/or the Media Access Control (MAC) layer of the transceiver 404. Transceiver 404 includes one or more receivers 420 and one or more transmitters 422.

eNB 402 comprises a Processor 409 coupled to a memory 413 and a transceiver 410. Memory 413 stores applications 408 for execution by the processor 409. The applications 408 could comprise any known or future application useful for managing wireless communications. At least some of the applications 408 may direct the base-station to manage transmissions to or from the user device 401.

Transceiver 410 comprises an uplink resource manager which enables eNB 402 to selectively allocate uplink PUSCH resources to the user device 401. As would be understood by one of skill in the art, the components of the uplink resource manager 412 may involve the physical (PHY) layer and/or the Media Access Control (MAC) layer of the transceiver 410. Transceiver 410 includes a Receiver 411 for receiving transmissions from various UE within range of the eNB and transmitter 414 for transmission to the various UE within range. The uplink resource manager executes instructions that control the operation of transceiver 410. Some of these instructions may be located in memory 413 and executed when needed. The resource manager controls the transmission resources allocated to each UE that is being served by eNB 402 and broadcasts control information via the physical downlink control channel PDCCH.

During MIMO transmission to UE 401 via transmitter 414 on PDSCH, eNB 402 monitors channel conditions to adapt to the prevailing condition. This includes monitoring the channel quality indicator (CQI) feedback provided by UE 401 on the uplink channel using condition monitoring logic 412 that is coupled to receiver 411. It also includes determining when the channel conditions are not conducive to adaptive precoding for spatial multiplexing transmission. One selection criterion is velocity of the UE. eNB 402 may estimate velocity of UE 401 using Doppler shift, for example.

When the condition logic determines the selection criterion is fulfilled, the eNB transmits to the UE using a spatial multiplexed signal with adaptive preceding. Adaptive precoding is performed by dynamically selecting a preceding matrix from codebook Table 1 or 2, depending on the number of transmitting antenna. Each time a selection is made, the index value is signaled to the UE so that it knows how to demodulate the received signal. Typically, for lower velocity operation, adaptive preceding is selected. The transmission signal is formed as generally illustrated with reference to FIG. 2.

When the selection criterion is not fulfilled, the eNB transmits to the UE using a spatial multiplexed signal with fixed preceding. Fixed precoding is performed by selecting one preceding matrix from codebook Table 1 or 2, depending on the number of transmitting antenna. When a selection is made, the index value is signaled to the UE so that it knows how to demodulate the received signal. Typically, for higher velocity operation, fixed precoding is selected. The transmission signal is formed as generally illustrated with reference to FIG. 2.

A typical eNB will have multiple sets of receivers and transmitters which operate generally as described herein to support hundreds or thousand of UE within a given cell. Each transmitter may be embodied generally by a processor 409 that executes instructions from memory 413 to perform the scrambling, mapping, and OFDM signal formation, using signal processing techniques as are generally known in the art.

### Other Embodiments

While the invention has been described with reference to illustrative embodiments, this description is not intended to be construed in a limiting sense. Various other embodiments of the invention will be apparent to persons skilled in the art upon reference to this description.

While described herein with reference to downlink transmission, an embodiment of the invention may be applied to uplink as well where multi-antenna uplink transmission is supported.

An embodiment may transmit using fixed precoding when the transmitted signal comprises multiple spatial layers and transmit using transmit diversity when the transmitted signal comprises a single layer.

Embodiments of this invention apply to any flavor of frequency division multiplex based transmission. Thus, the concept can easily be applied to: OFDMA, OFDM, DFT-spread OFDM, DFT-spread OFDMA, SC-OFDM, SC-OFDMA, MC-CDMA, and all other FDM-based transmission strategies.

A NodeB is generally a fixed station and may also be called a base transceiver system (BTS), an access point, or some other terminology. A UE, also commonly referred to as terminal or mobile station, may be fixed or mobile and may be a wireless device, a cellular phone, a personal digital assistant (PDA), a wireless modem card, and so on.

As described in general above, embodiment of the invention may perform all tasks described herein such as channel monitoring and preceding selection, formation of transmission signals, etc, using logic implemented by instructions executed on a processor. Another embodiment may have particular hardwired circuitry or other special purpose logic optimized for performing one or more to the tasks described herein.

As used herein, the terms “applied,” “coupled,” “connected,” and “connection” mean electrically connected, including where additional elements may be in the electrical connection path. “Associated” means a controlling relationship, such as a memory resource that is controlled by an associated port.

It is therefore contemplated that the appended claims will cover any such modifications of the embodiments as fall within the true scope and spirit of the invention.

What is claimed is:

1. A method for transmitting with multiple antennas, comprising:
selecting between adaptive channel-dependent preceding and fixed preceding based on a selection criterion;
transmitting using spatial multiplexing with adaptive precoding if the selection criterion is fulfilled; and
transmitting using spatial multiplexing with fixed preceding if the selection criterion is unfulfilled.

2. The method of claim 1, wherein transmitting using fixed preceding comprises:
mapping modulation symbols onto two or more transmission layers; and
precoding the modulation symbols across the transmission layer using a pre-determined precoder selected from a codebook.

3. The method of claim 1, wherein transmitting using fixed preceding comprises:
mapping modulation symbols onto two or more transmission layers; and
precoding the modulation symbols across the transmission layer using a selected precoder from a pre-determined subset of precoders from a codebook, wherein the precoder is selected from the pre-determined subset of precoders based on a pre-determined hopping pattern.

4. The method of claim 1, wherein:
the selection criterion comprises determining a velocity of a user equipment (UE) relative to a base station (eNB);
transmitting using spatial multiplexing with adaptive precoding occurs while the velocity is within a lower range; and
transmitting using spatial multiplexing with fixed preceding occurs while the velocity is not within the lower range.

5. The method of claim 2, wherein transmitting using fixed precoding further comprises receiving a channel quality indicator feedback transmission with the absence of a precoding matrix indicator.

6. The method of claim 1, wherein transmitting using fixed precoding is employed when the transmitted signal comprises multiple spatial layers and transmit diversity is employed when the transmitted signal comprises a single layer.

7. The method of claim 6, wherein the number of transmission layers is adapted based on a channel-dependent rank indicator feedback transmission.

8. The method of claim 2, wherein selecting one precoder further comprises signaling to a user equipment to indicate the selected precoder.

9. A method for receiving at a first node a signal transmitted from a second node with multiple antennas, comprising:
receiving a configuration message to indicate selection between adaptive channel-dependent precoding and fixed precoding based on a selection criterion;
receiving a signal that is spatially multiplexed using adaptive precoding if the selection criterion is fulfilled; and
receiving a signal that is spatially multiplexed using fixed precoding if the selection criterion is unfulfilled.

10. The method of claim 9, wherein receiving a signal that is spatially multiplexed using fixed precoding comprises receiving two or more transmission layers with modulation symbols mapped thereon, wherein the modulation symbols on each transmission layer were precoded using a preselected precoder selected from a codebook.

11. The method of claim 9, wherein transmitting using fixed precoding comprises receiving two or more transmission layers with modulation symbols mapped thereon, wherein the modulation symbols on each transmission layer were precoded using one matrix selected from a predetermined subset of decoders selected from a codebook based on a pre-determined hopping pattern.

12. The method of claim 9, wherein:
the selection criterion comprises determining a velocity of the first node relative to the second node;
receiving a signal that is spatially multiplexed using adaptive precoding occurs while the velocity is within a lower range; and
receiving a signal that is spatially multiplexed using fixed precoding occurs while the velocity is not within the lower range.

13. The method of claim 10, wherein receiving a signal with fixed precoding further comprises providing a channel quality indicator feedback transmission with the absence of a precoding matrix indicator.

14. The method of claim 9, wherein receiving a signal with fixed precoding occurs when the received signal comprises multiple spatial layers, and wherein transmit diversity is employed when the signal comprises a single layer.

15. The method of claim 14, wherein the number of transmission layers is adapted based on a channel-dependent rank indicator feedback transmission.

16. Apparatus for transmitting with multiple antennas, comprising:
processing logic operable to select between adaptive channel-dependent precoding and fixed precoding based on a selection criterion;
transmission logic coupled to the processing logic and to multiple antennas, the transmission logic operable form a transmission signal for transmission by the multiple antennas using spatial multiplexing with adaptive precoding if the selection criterion is fulfilled; and
the transmission logic being operable to form a transmission signal for transmission by the multiple antennas using spatial multiplexing with fixed preceding if the selection criterion is unfulfilled.

17. The apparatus of claim 16, the transmission logic being operable to map modulation symbols onto two or more transmission layers, and to precode the modulation symbols across each transmission layer using a pre-determined precoder selected from a codebook.

18. The apparatus of claim 16, the transmission logic being operable to map modulation symbols onto two or more transmission layers, and to precode the modulation symbols across each transmission layer using a selected precoder from a pre-determined subset of precoders from a codebook, wherein the precoder is selected from the pre-determined subset of precoders based on a pre-determined hopping pattern.

19. The apparatus of claim 16, wherein the processing logic is operable to determine a velocity of a user equipment (UE) relative to a base station (eNB) as the selection criterion;
the transmission logic being operable to form the transmission signal using spatial multiplexing with adaptive precoding occurs while the velocity is within a lower range; and
the transmission logic being operable to form the transmission signal using spatial multiplexing with fixed precoding occurs while the velocity is not within the lower range.

20. The apparatus of claim 16, wherein the transmission circuitry is operable to form the transmission signal using fixed precoding when the transmission signal comprises multiple spatial layers; and is operable to form the transmission signal for transmit diversity when the transmission signal comprises a single layer.
